(19) United States
(12) Patent Application Publication
(10) Pub. No.: US 2009/0149149 A1
(43) Pub. Date: Jun. 11, 2009

(54) Dual Gilbert Cell Mixer with Offset Cancellation

(76) Inventor: Leonardus C. H. Ruijs, Oss (NL)

Correspondence Address: SLATER & MATSIL, L.L.P., 17950 PRESTON RD, SUITE 1000, DALLAS, TX, 75252-5793, US

(21) Appl. No.: 12/366,302

(22) Filed: Feb. 5, 2009

Related U.S. Application Data
(63) Continuation of application No. PCT/IB2007/053138, filed on Aug. 8, 2007.

(30) Foreign Application Priority Data
Aug. 10, 2006 (EP) 06118709.2

(51) Int. Cl. H04B 1/26; G06G 7/14

(52) U.S. Cl. 455/323; 327/361

(57) ABSTRACT

An electronic device includes a first mixer portion having a first stage and a second stage, and a second mixer portion having a first stage and a second stage. A first electrical path is coupled to the first mixer portion and the second mixer portion, and a second electrical path is coupled to the first mixer portion and the second mixer portion. The first mixer portion is adapted to receive a first input signal on the first stage and a second input signal on the second stage. The second mixer portion is adapted to receive the second input signal on the first stage and the first input signal on the second stage.

This application is a continuation of co-pending International Application No. PCT/IB2007/053138, filed Aug. 8, 2007, which designated the United States and was published in English, and which claims priority to European Application No. 06118709.2 filed Aug. 10, 2006, both of which applications are incorporated herein by reference.

### FIELD OF THE INVENTION

The present invention relates to an electronic device including a mixer for mixing two input signals.

### BACKGROUND

Frequency translation in electronic data processing systems is usually performed by devices known as mixers. There are various different architectures for mixing two signals for modulation purposes covering simple single ended, single balanced mixers, and double balanced mixers providing, e.g., improved isolation from the local oscillator (LO). The most popular double balanced mixer used in radio frequency integrated circuit designs is the Gilbert cell mixer. The Gilbert cell is basically a cross-couple differential amplifier.

As generally known by those skilled in the art, the Gilbert cell constitutes a double balanced modulator, which eliminates the carrier frequency and effectively implements a mixer that generates only the sum and the difference of the two frequencies of the signals to be modulated. The Gilbert cell mixer provides a symmetric design to remove the unwanted radio frequency and LO frequency output signals from the intermediate frequency (IF) output signal.

Generally, the Gilbert cell double balanced mixer comprises a first upper layer stage of four transistors receiving a differential LO input and a second lower layer stage including two transistors for receiving a differential radio frequency (RF) input. The RF signal is applied to the transistors of the lower stage, which perform a voltage-to-current conversion. The transistors of the upper layer stage implement a multiplication function by multiplying the linear RF signal current from the lower layer stage with the LO signal applied across the upper stage.

As for all electronic circuits, and, in particular, for integrated circuits (IC), the Gilbert cells have parasitic capacitances or parasitic resistances dependent on the technology, the design and the layout of the ICs. A general problem with all mixer cells, such as Gilbert cell mixers, consists in distortion of the output signals due to non-ideal electric properties of the devices. A particular disadvantage is an offset of the output signal entailing undesired signal properties of the output signals. Although the offset deficiencies of mixers, in particular, of Gilbert cell mixers, are often discussed and broadly known by those skilled in the art, there is no practical and simple solution disclosed in the prior art. In particular, there is no mixer configuration that takes account of distortion and offsets for square wave input signals. Although there are solutions known from the prior art using dual Gilbert cell mixer configurations, mixing of square wave signals is not considered.

### SUMMARY OF THE INVENTION

In one aspect, the present invention provides an electronic device for a mixer circuit for processing input signals providing enhanced quality of the output signals. In another aspect, the present invention improves mixing of signals having relatively steep slopes, more specifically the mixing of square waves.

In one embodiment, an electronic device includes a first mixer portion having a first upper stage and a second lower stage, as well as a second mixer portion having a first upper stage and a second lower stage. The mixer portions are both coupled to a first electrical path, and a second electrical path. The electrical paths may be the loads of the mixer portions such that the electrical paths provide the output pins for providing the output signals. Further, the first mixer portion is adapted to receive a first input signal on the first stage and a second input signal on the second stage, whereas the second mixer portion is adapted to receive the second input signal on the first stage and the first input signal on the second stage. Accordingly, the input signals of the first and second mixer portions are coupled to the input signals in a swapped manner with respect to each other. Further, the mixer portions share the load which is implemented by two electrical paths. Accordingly, there are two basic mixer portions combined to operate as one single mixer wherein the electrical paths for providing the currents of the respective mixer portions are activated in an alternating manner as for the conventional single mixer as the inputs of the mixer stages are not applied equally to both stages. The doubling of the mixer portions is used to compensate the deficiencies of only one of the mixer portions, which is conventionally provided for mixing two input signals.

Such a single mixer device provides parasitic capacitances, resistors, etc, due to non-ideal properties of the electronic devices. Typically, as for a single mixer, the same inherent parasitic elements are charged and discharged through the same electrical paths, in particular, via the same load. If an output node of the mixer experiences a specific first parasitic capacitor that is always charged or discharged via the same resistance (i.e., the same load device), the voltage levels deviate constantly by a specific amount from the ideal value. A typical consequence is a constant offset of the output signal. An embodiment of the present invention provides an electronic device to overcome this deficiency. According to this aspect of the invention, the mixer portions have two stages, which are the upper and lower layer stages of a mixer, such as, for example, a Gilbert cell mixer. The stages are typically implemented as differential pairs receiving the input signals to be mixed. However, the electronic device according to this aspect of the invention has a particular configuration, such that the input signals are swapped between the two mixer portions. Accordingly, the input signals switch the two electronic paths, which provide typically the load for the differential stages and the outputs, in an alternating manner between the two mixer portions such that parasitic capacitors are charged and discharged via alternating paths. The deterioration of the output signal is suppressed if the input signals are swapped between the two mixer portions, i.e., between the first and second stage of each mixer portion. This way, every time the polarity of one of the input signals changes, the activation of the electronic paths is changed. If the electronic paths are the loads, the term activating relates, e.g., to the currents through the electrical paths. So, a current is alternately drawn through one of the load devices (resistors or transistor loads). As a result, the mismatch of the signal on the load devices, such as load resistors, in the electrical paths is also suppressed. Although resistive loads in each electrical path are simpler to implement they are more sensitive to tolerances and non-idealities than current sources, which are also used as loads. Devices using current sources as loads are not as sensitive to the problems as described above.

According to another aspect of the invention the second stages of the first and second mixer portions provide substantially the same capacitive load to the respective first stages. Though a considerable effect is already reached if a constant alternating, and exchanging of the electrical paths and the parasitic capacitances or the like is carried out, the effect can be improved if the second stages of the mixer portions are matched. The parasitic capacitors of the second stages provide a considerable capacitive load. Particularly, for Gilbert cell mixers in combination with square waves, the parasitic capacitances of the second stage are constantly loaded via the same load devices, i.e. via the same electrical path. According to this aspect of the present invention, the second stage of the two mixer portions are matched with respect to each other. Accordingly, not only the electrical properties of the active devices are matched, but the parasitic effects are considered separately. As the charging and discharging of the parasitic capacitances of both of the second stages occurs alternately via the two paths, the error introduced by mismatch is additionally reduced. Another positive effect can be achieved, if according to still another aspect of the invention the first and second mixer portions and the first and second electrical paths are matched with respect to their electrical properties. This aspect relates to all electrical properties rather than to the non-ideal electronic components.

According to an aspect of the present invention the electronic device is especially adapted for mixing two square wave input signals of the same frequency. Goals of some embodiments of the present invention are particularly solved if an electronic device as set out above is used for processing square wave input signals of substantially the same frequency.

While the transistors of the first upper and second lower layer stage of the mixer are continuously turned on and turned off in response to the input signals, the parasitic components are charged and discharged. As long as the input signals have sinusoidal waveforms, the charging and discharging effects of the parasitic elements are distributed in a rather homogenous manner. However, if a mixer cell, in particular, a double balanced Gilbert cell, is used for processing of square-wave signals, the output signal is affected considerably. This is due to the rapid switching and the relatively steep slopes of the signals. The slopes entail rapid charging and discharging of capacitive loads, in particular, of the capacitive parasitic loads in the second lower layer stages. The charging and discharging occurs in close temporary correlation with the slopes of the signals, i.e., immediately after a transition of the input signal which is applied to the second stage. Accordingly, only the transitions of the input signals applied to the second stages cause considerable charging and discharging effects, but not the transitions, i.e., the changes of polarity, of the other input signal, which is applied on the upper layer stage. If the two input signals which are to be mixed have substantially the same frequency the merits of this aspect of the present invention are most valuable. For similar frequencies of the input signals the switching sequence of the mixer stages (upper and lower layer stage) is particularly disadvantageous for single mixer cells as only the transitions of the input signal applied to the lower layer stage trigger a charging and discharging but always via the same electrical paths (i.e., the same loads). Accordingly, the deterioration of the output signals is worse than in the case of smoothly changing signals like sinusoidal waveforms. It is therefore a special aspect of the present invention to apply a dual mixer as set out above having shared electrical paths as loads and swapped input signals for square wave input signals.

The above configurations and applications are particularly useful if the first mixer portion has a Gilbert cell configuration and the second mixer portion has a Gilbert cell configuration, and the two Gilbert cells share the first electrical path and the second electrical path, i.e., the two Gilbert cells share the same loads. Accordingly, an embodiment of the present invention provides also a first Gilbert cell mixer having a first input for inputting a first signal and a second input for inputting a second signal, wherein the first and second input signals are to be mixed by the first Gilbert cell mixer, a second Gilbert cell mixer having a first input for inputting the second input signal and a second input for inputting the first signal, wherein the first Gilbert cell mixer and the second Gilbert cell mixer share the same load devices, and the input signals of the first Gilbert cell mixer are swapped with respect to the input signals of the second Gilbert cell mixer.

According to an aspect of the invention the first electrical path and the second electrical path of the electronic device each provide an output. Between the two outputs, the electronic device provides a differential output signal. The differential or symmetric output signal is more robust against noise and offsets.

According to an aspect of the invention the electronic device further includes a limiter or a comparator for processing the input signals in order to have square wave first and second input signals. As many applications only provide sinusoidal signals it is advantageous if the electronic device provides means to transform those signals into square waves. According, to this aspect of the invention, the input signals are rendered independent of their amplitudes. Further, a low pass filter for filtering the output signal of the first and second mixer portions can be provided in order to generate the mean value of the output signal. According to the above aspects the present invention can be used for an improved reactance detector including a phase detector that can be used for detecting and determining a reactance. Accordingly, a coil as a sensing means is coupled in series with a component of which the reactance is to be determined. The differential voltage across the sensing coil is used as one input signal. The phase shift between the current through the coil and the differential voltage is ideally 90 degrees. The voltage on the input node of the sensing coil is used as the second input signal. Before being applied to the mixer, the two input signals can be passed through a limiter or a comparator in order to have square input signals. The input signals are mixed by a dual mixer configuration as described above according to an embodiment of the present invention. Accordingly, the output signal, i.e., the mean value of the square output signal, is an indicator of the phase difference and therefore a measure of the reactance. The limiter makes the input signals independent of the amplitudes of the input signals and the output signal of the phase detector shows a linear relation with respect to the phase difference. As the mixer is adapted to process square waves with reduced offset and distortion according to an embodiment of the present invention, the low pass filtered output signal of the phase detector is a precise indicator of the reactance of the component that is coupled to the sensing coil. However, in a first configuration, the sensing inductor is included in the reactance to be determined. In a second configuration the sensing inductor could be excluded if the voltage on the other node of the sensing inductor was used.

In another aspect, the present invention provides a method of designing an electronic device, wherein the method includes the following steps: providing a first mixer portion having a first stage and a second stage, providing a second mixer portion having a first stage and a second stage, providing a first electrical path and coupling the first electrical path to the first mixer portion and the second mixer portion, providing a second electrical path and coupling the second electrical path to the first mixer portion and the second mixer portion, providing inputs to the first mixer portion for receiving a first input signal on the first stage and a second input signal on the second stage, providing inputs to the second mixer portion for receiving the second input signal on the first stage and a first input signal on the second stage, designing the second stages of the first and second mixer portions to have their electrical properties matched.

### BRIEF DESCRIPTION OF THE DRAWINGS

These and other aspects of the invention will be apparent from and elucidated with reference to the embodiments described hereinafter. In the following drawings:

FIG. 1 shows a simplified schematic of a Gilbert cell according to the prior art;

FIG. 2 shows waveforms of the typical mixer operation of an ideal mixer;

FIG. 3 shows a simulated output waveform of the Gilbert cell of FIG. 1 compared to an ideal output waveform;

FIG. 4 shows a simplified schematic of a first embodiment according to the present invention;

FIG. 5(a) shows a simulated output waveform for the circuit shown in FIG. 4 compared to an ideal output waveform;

FIG. 5(b) shows the simulated output waveform of the standard Gilbert cell mixer according to FIG. 1 compared to the simulated output waveform of the first embodiment according to the present invention;

FIG. 6(a) shows typical input waveforms;

FIG. 6(b) shows the corresponding output waveform;

FIG. 7 shows a typical reactance detector arrangement; and

FIG. 8 shows the phase difference between the voltage and the current at the detector output.

### DETAILED DESCRIPTION

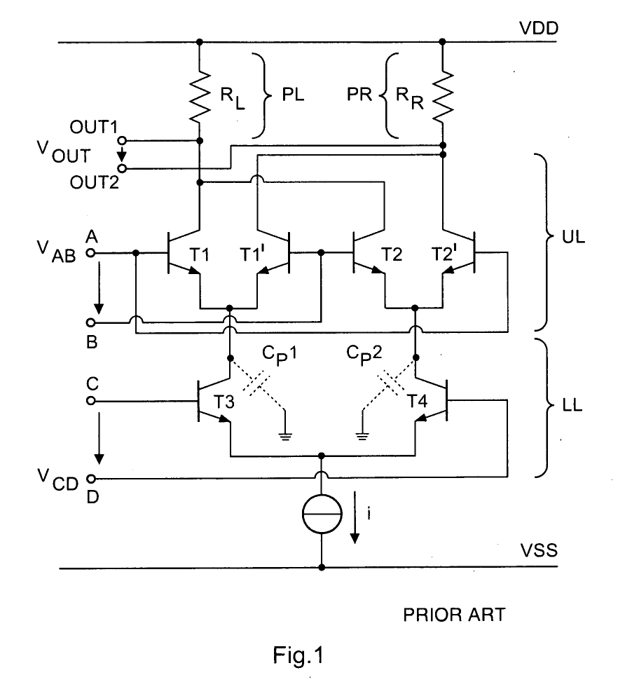

FIG. 1 shows a simplified schematic of a double balanced Gilbert cell mixer according to the prior art. The Gilbert cell mixer includes two electrical paths PL, PR including output resistors R_{L} and R_{R}. The electrical paths PL, PR are coupled to VDD via output resistors R_{R}, R_{L} and with the other end to the differential transistor pairs T1, T1′ and T2, T2′. The load or output resistor R_{L} is coupled to transistors T1 and T2. The output resistor R_{R} is coupled to T1′ and T2′. The inputs of the transistors T1 and T2′ are coupled to a first input pin A and the base of transistors T1′ and T2 are coupled to input pin B. The emitters of the two transistors T1 and T1′ are coupled both to the collector of transistor T3. The base of transistor T3 provides a further input pin C. Likewise, the emitters of transistors T2 and T2′ are coupled both to the collector of transistor T4, which provides a fourth input pin D on its base. Transistors T3 and T4 have a common emitter, which is coupled to the current source sinking a current i from the common emitter circuit consisting of T3 and T4. The basic functionality of the Gilbert cell as shown in FIG. 1 is well known in the art. A first signal V_{AB} is applied between the inputs A and B. The second signal V_{CD} is applied to inputs C and D. The two input signals V_{AB} and V_{CD} are to be mixed. The result of the mixing is an output signal V_{OUT} to be retrieved from output pins OUT1 and OUT2. Further, FIG. 1 shows two capacitors (dashed) Cp1 and Cp2, which represent the inherent capacitances of the transistors T3 and T4 as well as the sum of the parasitic capacitances of nodes, to which the capacitors Cp1 and Cp2 are connected. The Gilbert cell mixer can be separated into two stages, an upper layer stage UL and a lower layer stage LL. Accordingly, the capacitors Cp1 and Cp2 are the capacitive loads of the second stage to be experienced by a current drawn from the respective first differential pair T1, T1′ and second differential pair T2, T2′ of the first stage UL.

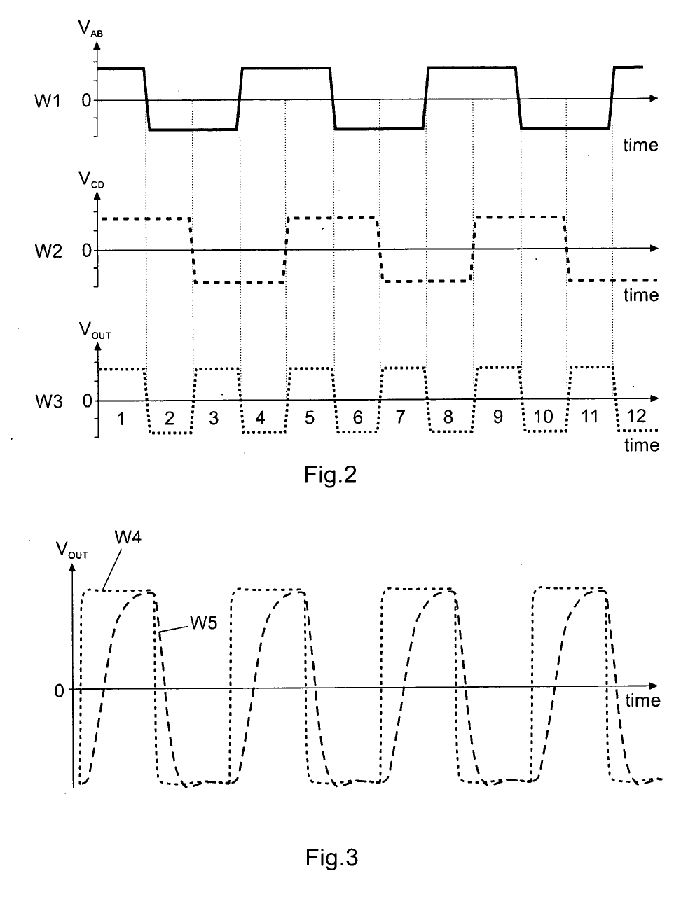

FIG. 2 shows two typical and ideal representatives W1 and W2 of input waveforms for V_{AB} and V_{CD} and the ideal resulting output waveform W3 being in the ideal case the mixed output signal of the Gilbert cell mixer of FIG. 1. The operation of the Gilbert cell mixer of FIG. 1 for input signals like W1 and W2 of FIG. 2 is now illustrated by reference to Table 1. The first row indicates sequences 1 to 12 relating to the states of the input signals V_{AB} and V_{CD} as indicated in FIG. 2. V_{AB}=1 indicates a positive polarity where input pin A is HIGH compared to B, while V_{AB}=−1 refers to the reverse polarity. The same notation is used for V_{CD}. It could be derived from the logical combination of V_{AB} and V_{CD} whether a current is drawn through resistor R_{L} or through resistor R_{R}. The respective result is indicated in row four of Table 1.

TABLE 1

| | | | | | | | | | | | | | |
|---|---|---|---|---|---|---|---|---|---|---|---|---|---|
| 1 | Sequence # | 1 | 2 | 3 | 4 | 5 | 6 | 7 | 8 | 9 | 10 | 11 | 12 |
| 2 | Polarity of V_{AB} | 1 | −1 | −1 | 1 | 1 | −1 | −1 | 1 | 1 | −1 | −1 | 1 |
| 3 | Polarity of V_{CD} | 1 | 1 | −1 | −1 | 1 | 1 | −1 | −1 | 1 | 1 | −1 | −1 |
| 4 | I in resistor | R_{L} | R_{R} | R_{L} | R_{R} | R_{L} | R_{R} | R_{L} | R_{R} | R_{L} | R_{R} | R_{L} | R_{R} |
| 5 | Cp charged | Cp2 | — | Cp1 | — | Cp2 | — | Cp1 | — | Cp2 | — | Cp1 | — |
| 6 | Cp discharged | Cp1 | — | Cp2 | — | Cp1 | — | Cp2 | — | Cp1 | — | Cp2 | — |
| 7 | i_{charge} in resistor | R_{R} | — | R_{R} | — | R_{R} | — | R_{R} | — | R_{R} | — | R_{R} | — |
| 8 | i_{discharge} in resistor | R_{L} | — | R_{L} | — | R_{L} | — | R_{L} | — | R_{L} | — | R_{L} | — |
| 9 | Voltage higher on | R_{L} | — | R_{L} | — | R_{L} | — | R_{L} | — | R_{L} | — | R_{L} | — |
| 10 | Voltage lower on | R_{R} | — | R_{R} | — | R_{R} | — | R_{R} | — | R_{R} | — | R_{R} | — |

Whenever V_{CD} changes the polarity, i.e., the sign, one parasitic capacitor Cp1 or Cp2 is charged and the other is discharged. Charging one of Cp1 or Cp2 requires an additional current through one of the resistors R_{L} or R_{R} dependent on the value of V_{AB}. Discharging of the parasitic capacitors Cp1 and Cp2 requires less current to be drawn through one of the resistors R_{L} and R_{R}, which also depends on the value of V_{AB}. The specific sequence of input signals V_{AB} and V_{CD} has the effect that it is always the same resistor, either R_{L} or R_{R}, through which the parasitic capacitors Cp1 and Cp2 are charged or discharged. This phenomenon is indicated in rows 5 and 6 of Table 1. Accordingly, in sequence #1, the current through resistor R_{R} charges Cp2 and capacitor Cp1 is discharged at cost of current through R_{L}. In sequence #3, a current through R_{R} charges Cp1, and Cp2 is discharged at cost of current through R_{L}. So, despite the fact that parasitic capacitors are charged and discharged in an alternating manner, the resistors used for charging and discharging remain unchanged. This effect occurs despite the polarity of V_{AB} it changes also such that a change of polarity of either V_{AB} or V_{CD} occurs always from sequence to sequence. As the charging and discharging effect of the capacitors Cp1 and Cp2 typically happens very close to the edges of V_{CD}, and the change of polarity of V_{AB} has no influence on the charging or discharging of the parasitic capacitors Cp1 and Cp2, the charging transistor is always R_{R} and the discharging transistor is R_{L}. Further, as indicated in rows 9 and 10 of Table 1, voltages on R_{L} and R_{R} are consistently different during sequences #1 to #12. A consequence of this situation is that the output waves become asymmetrical.

FIG. 3 shows a simulated output waveform W5 of the conventional double balanced Gilbert cell mixer shown in FIG. 1 compared to the ideal output waveform W4. The finite transfer frequency of transistors T1, T1′ and T2 and T2′, as well as the transistors T3 and T4, and further parasitic capacitances on the output nodes (not shown) basically provide a filtering of the square waves and reduce the harmonics such that the waveforms become smoother. The capacitances at the output nodes are symmetric and they will not cause asymmetry in the output signals.

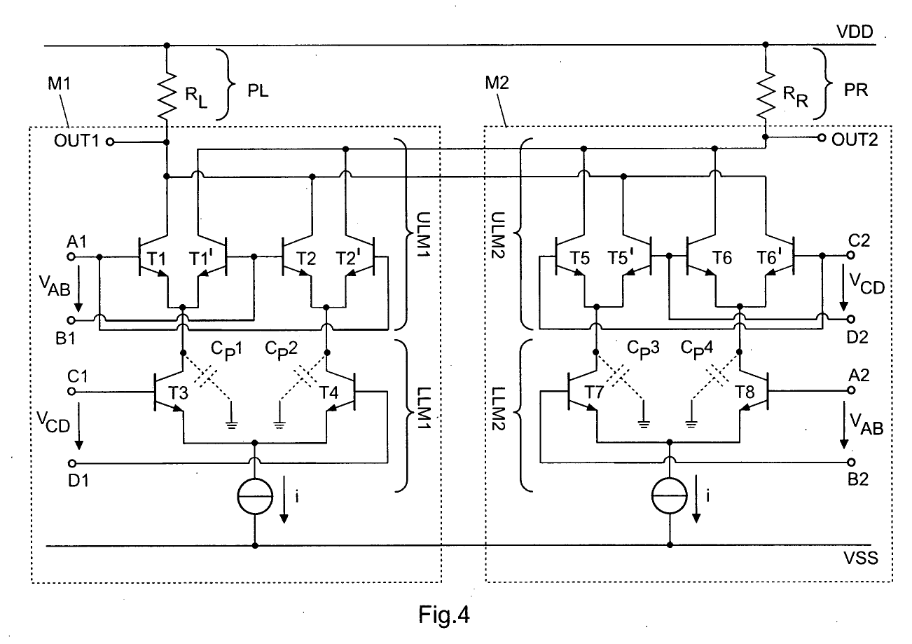

FIG. 4 shows a simplified schematic of an embodiment of the present invention. According to FIG. 4, there is a first Gilbert cell mixer M1 in the same configuration as shown in FIG. 1. The input and output signals V_{AB}, V_{CD} are also similar in FIG. 1. As for FIG. 1, the first Gilbert cell mixer M1 has transistors T1, T1′, T2, T2′, T3, T4 and capacitors Cp1 and Cp2. The operation of the first Gilbert cell mixer M1 is basically the same as described above with respect to the Gilbert cell mixer in FIG. 1. There is a second Gilbert cell mixer M2 including the transistors T5, T5′, T6, T6′, T7, T8, which is similar to Gilbert cell mixer M1. The second Gilbert cell mixer M2 has capacitors Cp3 and Cp4 representing the sum of the parasitic capacitances on the respective collectors of transistors T7 and T8. The transistors T1, T1′, and T2, T2′ of the first mixer portion M1 represent the upper layer stage ULM1 of the first mixer portion. The transistors T3 and T4 are considered to be the lower layer stage LLM1 of the first mixer portion M1. The same notation is applied to the second mixer portion M2. Accordingly, transistors T5, T5′, and T6, T6′ represent the upper layer stage ULM2 of the second mixer portion M2. The lower layer stage LLM2 of the second mixer portion M2 includes transistors T7 and T8. The upper layer stage ULM1 of the first mixer portion M1 is coupled to load resistors R_{L} and R_{R} in the same manner as described with respect to FIG. 1. However, the upper layer stage of ULM2 of mixer portion M2 are also coupled to R_{R} and R_{L}, but in a reversed manner. Accordingly, T5 is coupled to R_{R}, T5′ to R_{L}, T6 to R_{R}, and T6′ to R_{L}. Additionally, the input signals V_{AB} and V_{CD} are applied to the inputs A1, B1, C1, and D1. The two input signals V_{AB} and V_{CD} are also applied to input pins A2, B2, C2, D2, wherein the input signals are swapped for the second mixer portion M2. Accordingly, the upper layer stage ULM2 of the second mixer portion M2 receives the input signal of the lower layer stage LLM1 of the first mixer portion. The lower mixer stage LLM2 of the second mixer portion receives the input signal of the upper layer stage ULM1 of the first mixer portion M1. The output signals are provided by respective output pins OUT1 and OUT2 on the electrical path PL and PR, which include the load resistors R_{L} and R_{R}. The output voltage V_{OUT} is provided between the output pins OUT1 and OUT2 in the same manner as shown for FIG. 1. Further, the output signal V_{OUT} is the mixed version of input signals V_{AB} and V_{CD} as explained for FIG. 1.

The operation of the dual Gilbert cell mixer configuration of FIG. 4 is now explained by reference to Table 2.

TABLE 2

| | | | | | | | | | | | | | |
|---|---|---|---|---|---|---|---|---|---|---|---|---|---|
| 1 | Sequence # | 1 | 2 | 3 | 4 | 5 | 6 | 7 | 8 | 9 | 10 | 11 | 12 |
| 2 | Polarity of V_{AB} | 1 | −1 | −1 | 1 | 1 | −1 | −1 | 1 | 1 | −1 | −1 | 1 |
| 3 | Polarity of V_{CD} | 1 | 1 | −1 | −1 | 1 | 1 | −1 | −1 | 1 | 1 | −1 | −1 |
| 4 | I in resistor | R_{L} | R_{R} | R_{L} | R_{R} | R_{L} | R_{R} | R_{L} | R_{R} | R_{L} | R_{R} | R_{L} | R_{R} |
| 5 | Cp charged | Cp2 | Cp4 | Cp1 | Cp3 | Cp2 | Cp4 | Cp1 | Cp3 | Cp2 | Cp4 | Cp1 | Cp3 |
| 6 | Cp discharged | Cp1 | Cp3 | Cp2 | Cp4 | Cp1 | Cp3 | Cp2 | Cp4 | Cp1 | Cp3 | Cp2 | Cp4 |
| 7 | i_{charge} in resistor | R_{R} | R_{L} | R_{R} | R_{L} | R_{R} | R_{L} | R_{R} | R_{L} | R_{R} | R_{L} | R_{R} | R_{L} |
| 8 | i_{discharge} in resistor | R_{L} | R_{R} | R_{L} | R_{R} | R_{L} | R_{R} | R_{L} | R_{R} | R_{L} | R_{R} | R_{L} | R_{R} |
| 9 | Voltage higher on | R_{L} | R_{R} | R_{L} | R_{R} | R_{L} | R_{R} | R_{L} | R_{R} | R_{L} | R_{R} | R_{L} | R_{R} |
| 10 | Voltage lower on | R_{R} | R_{L} | R_{R} | R_{L} | R_{R} | R_{L} | R_{R} | R_{L} | R_{R} | R_{L} | R_{R} | R_{L} |

It is assumed that the two waveforms W1 and W2 shown in FIG. 2 are applied as V_{AB} and V_{CD} to the circuitry shown in FIG. 4. The second Gilbert cell mixer portion M2 in FIG. 4 compensates the offset being produced by the single Gilbert mixer shown in FIG. 1, if two square wave signals of substantially the same frequency are applied to the mixer. As before, there are sequences #1 to #12 representing the states of the input signals during the periods 1 to 12 as indicated in FIG. 2. If V_{AB} is positive, this state is represented by 1 in the second row of Table 2. A negative V_{AB} is indicated by −1. The same notation is used for V_{CD} in the third row of Table 2. Row 4 of table 2 indicates whether a current is drawn through load resistor R_{L} or through load resistor R_{R}. Rows 5 and 6 denote the respective parasitic capacitors Cp1 to Cp4, being charged or discharged by the current through resistors R_{L} or R_{R} respectively. Accordingly, the charging and discharging currents of capacitors Cp1, Cp2, Cp3, and Cp4 are now spread over all capacitors, such that the charging and discharging currents are drawn via R_{R} and R_{L} in an alternating manner. Row 7 of Table 2 indicates that R_{L} and R_{R} alternately charge the capacitors. The same effect occurs for the discharging of the capacitors as shown in row 8 of Table 2. Accordingly, the voltages on R_{L} and R_{R} are also changed continuously from sequence to sequence. Due to this alternation of charging and discharging the capacitors Cp1 to Cp4 through alternating resistors, the output signal between output pins OUT1, OUT2 has not the same offset as for the single mixer cell. The asymmetry of the standard Gilbert cell mixer is reduced by adding a second mixer portion M2 and coupling the electrical path PL and PR to both mixer portions M1 and M2 as shown in FIG. 4. As indicated in Table 2 and as shown in FIG. 2, the input signals V_{AB} and V_{CD} having the waveforms W1 and W2 provide alternating transitions from a sequence to the subsequent sequence. The configuration shown in FIG. 4 takes particular account of input signals having the characteristics shown in FIG. 2. The input waveforms W1 and W2 have square waveforms and substantially the same frequency. Although an embodiment of the present invention is particularly useful to square waves of the same frequency, there is also a positive effect for waveforms being rather an approximation of the waveforms W1 and W2 shown in FIG. 2.

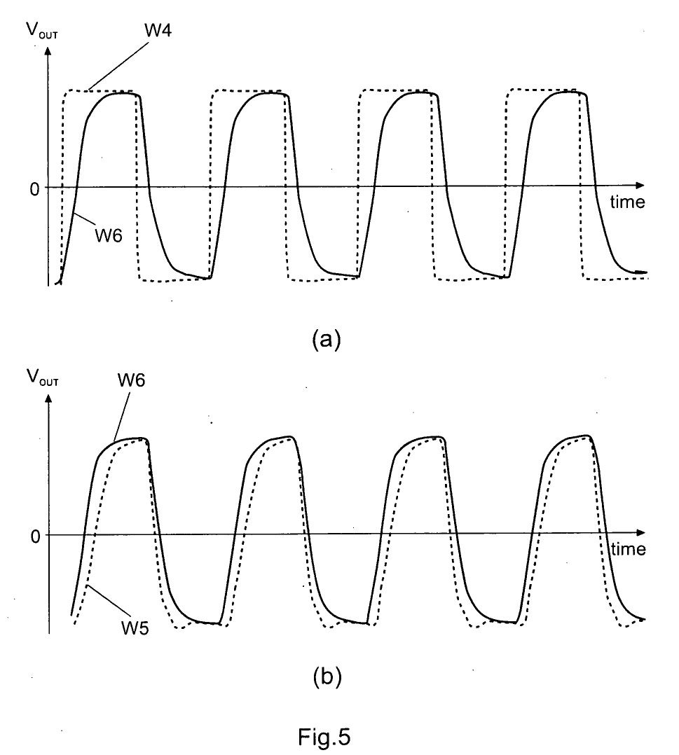

FIG. 5(a) shows the ideal output waveform W4 and a simulated output waveform W6 of the dual Gilbert cell mixer configuration of FIG. 4. Accordingly, the simulated waveform W6 is more symmetric with respect to the middle line of FIG. 5(a) as the simulated output waveform W5 of FIG. 3. FIG. 5(b) shows W5 (dashed line) and W6 in a single graph. Accordingly, W6 is more symmetric than W5.

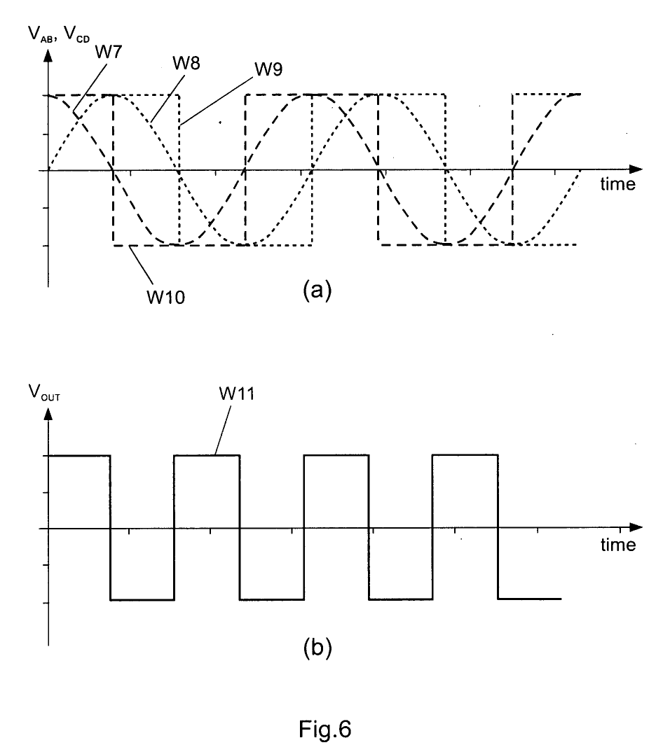

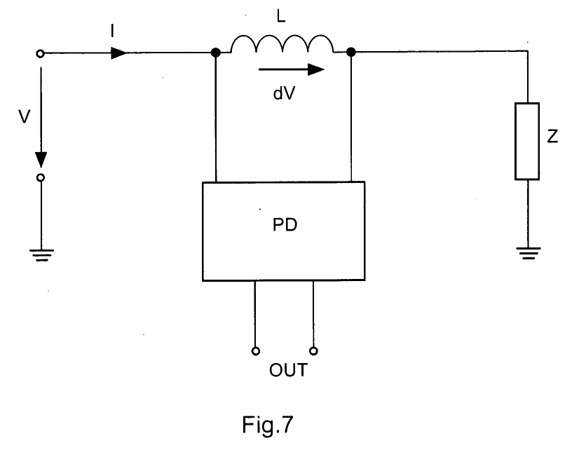

An embodiment of the present invention is useful for square waves of substantially the same frequency. Such waveforms can be produced as illustrated in FIGS. 6(a) and 6(b). FIG. 6(a) shows two sinusoidal waveforms W7 and W8. W7 and W8 can be applied to a limiter or to a comparator. The output of the limiter or comparator are the square waves W10 and W9, which are the limited waves of sinus signals W7 and W8 respectively. As sinusoidal waveforms W7 and W8 have the same frequency, and as they are 90° out of phase, the two corresponding square waves W9 and W10 have strictly alternating and equidistant transitions. FIG. 6(b) shows the result, if waveforms W9 and W10 are passed through an ideal mixer. The product of the limited input waves W9, W10 is square wave W11. The duty cycle of the product shown in FIG. 6(b) depends on the phase difference of the input waves which is 50:50 for the ideal case shown in FIG. 6(b). For a 50:50 duty cycle ratio, the mean value of the output wave is zero. If the two signals having waveforms W9, W10 deviate from a 90° phase difference, the mean value of the product of the two input waves represented by the output waveform W11 of FIG. 6(b) is a measure of an additional phase difference of the two signals. Typically, the output wave W11 would be passed through a low pass filter in order to extract the mean value.

Embodiments of the invention can also be used for the detection of the imaginary part of an impedance, the reactance, or the phase difference between a voltage and a current in a configuration as shown in FIG. 7. FIG. 7 shows a typical application of a phase mixer according to an embodiment of the present invention. Accordingly, the dual Gilbert cell mixer shown in FIG. 4 can be used in a phase detector PD for determining an impedance Z. The phase detector PD is coupled to the ends of a coil L. The voltage V on the input node of the coil L and the differential voltage dV across the coil are applied to the phase detector PD. The relation between the voltage V and the current I depends on the sum of the impedance Z and the impedance of the coil L. For an ideal coil L the phase shift between the current I and dV is 90°.

Phase detector PD includes a mixer configuration according to an embodiment of the present invention as shown in FIG. 4. Before signals V and dV are applied to the mixer portions (for example, to M1 and M2 as input signals V_{AB} and V_{DC} shown in FIG. 4), V and dV are passed through a limiter or comparator (not shown) in order to produce square waveforms as explained with respect to FIG. 6. This results, for example, in waveforms such as W9 and W10 shown in FIG. 6(a) for dV and V. If dV has a 90° phase shift with respect to the voltage V, the mixer of phase detector PD provides a square wave with a 50:50 duty cycle. The square wave output can be filtered by a low pass filter in order extract the mean value. For a 50:50 duty ratio the mean value is 0. The mean value can be used as an output signal OUT of PD. However, PD will only provide a mean value of 0, if the impedance on node V is real. If Z varies, the output OUT of PD indicates the phase shift.

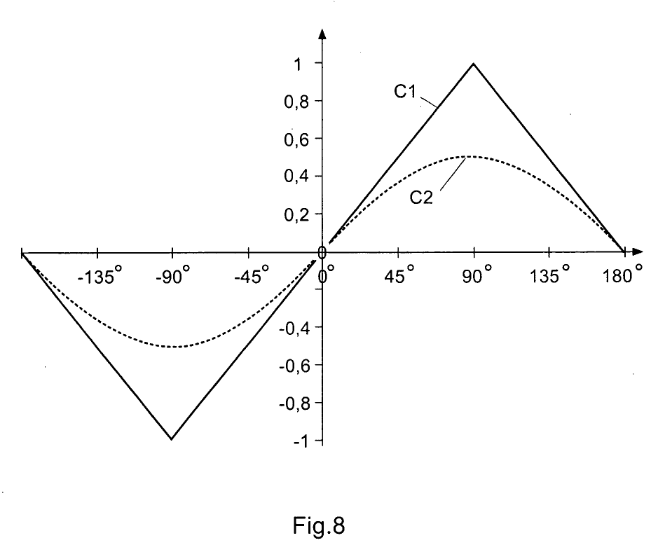

FIG. 8 shows the output of the phase detector PD shown in FIG. 7 as a function of the reactance at node V. There are two curves C1 and C2. C1 would be the output of a phase detector PD using a mixer according to the prior art (e.g., the one shown in FIG. 1) and sinusoidal input signals V and dV. C2 is the output signal OUT of a phase mixer PD as shown in FIG. 7 using a mixer according to an embodiment of the present invention as shown in FIG. 4 to which square waves are applied. For a real load at node V, being the impedance Z and the coil L together, current I and voltage V are in phase. As dV and I are always 90° out of phase, the output wave of the mixer will have a 50:50 duty cycle and the mean value of the output wave of the mixer will then be zero. Both curves C1 and C2 show the same value. As shown in FIG. 8, using the square waves has many advantages. The output signal OUT, being the mean value of the mixed input square wave signals V and dV is linearly dependent on the phase difference of dV and V as indicated by curve C1. This improves the applicability and the precision of the device. However, C2 shows a rather sinusoidal relationship for the sinusoidal input signals which is more complicated to handle and to evaluate. Even if square waves were applied to the mixer in FIG. 1, the OUT vs. phase curve would be shifted with respect to the x-axis due to the offsets. Therefore, if a mixer arrangement as shown in FIG. 4 is used, the result is more precise and reliable. Accordingly, limiting the input signals provides equal amplitudes of the mixer inputs and renders the result independent from the input amplitudes. As the amplitudes of V and dV might be rather different, dependent on the frequency, the value L of the sense coil and the connected load Z, the absolute value of the output signals would be meaningless except the sign which could indicate whether a capacitive or an inductive load is present. Thus the limited square input waves for the mixer provides a detection system PD (in a certain dynamic range) which is independent to amplitude variations and provides a linear phase to the output relationship.

Further, using an inductor L as a sensing means reduces power consumption as an inductor provides practically only little electrical resistance, and therefore little losses (L is ideally lossless). Further, dV ideally has a phase difference with respect to I of 90°. Accordingly, the output of the phase detector PD is 0 when V and I are in phase (V and dV 90 degrees out of phase).

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single mixer portion or a single stage or other unit may fulfill the functions of several items recited in the claims. The mere fact that certain features are recited in mutually different dependent claims does not indicate that a combination of these features cannot be used to advantage. Any reference signs in the claims should not be construed as limiting the scope.

What is claimed is:

1. An electronic device comprising:
a first mixer portion having a first stage and a second stage;
a second mixer portion having a first stage and a second stage;
a first electrical path being coupled to the first mixer portion and the second mixer portion; and
a second electrical path coupled to the first mixer portion and the second mixer portion;
wherein the first mixer portion is adapted to receive a first input signal on the first stage and a second input signal on the second stage, and
wherein the second mixer portion is adapted to receive the second input signal on the first stage and the first input signal on the second stage.

2. The electronic device according to claim 1, wherein the second stages of the first and second mixer portions provide substantially the same capacitive load to the respective first stages.

3. The electronic device according to claim 1, wherein the first and second electrical paths both provide a resistive load to the first and the second mixer portions.

4. The electronic device according to claim 3, wherein the resistive load of each electrical path comprises a resistor.

5. The electronic device according to claim 1, wherein the first and second mixer portions and the first and second electrical paths are matched with respect to their electrical properties.

6. The electronic device according to claim 1, wherein the first and the second mixer portions are adapted to process square wave input signals.

7. The electronic device according to claim 6, wherein the electronic device is adapted for mixing two square wave input signals of a same frequency.

8. The electronic device according to claim 1, wherein the first mixer portion has a Gilbert cell configuration and the second mixer portion has a Gilbert cell configuration.

9. The electronic device according to claim 8, wherein the two Gilbert cells share the first electrical path and the second electrical path and each provide an output for providing a differential output signal.

10. The electronic device according to claim 1, further comprising a limiter for processing the first and second input signals in order to create square wave first and second input signals.

11. The electronic device according to claim 1, further comprising a comparator for processing the first and second input signals in order to create square wave first and second input signals.

12. The electronic device according to claim 1, further comprising a low pass filter for filtering an output signal of the first and second mixer portions.

13. The electronic device according to claim 12, wherein the filter provides a mean value of the output signal.

14. The electronic device according to claim 1, wherein the electronic device comprises a reactance detector.

15. The electronic device according to claim 14, further comprising an inductor for determining a reactance.

16. A method of processing square wave signals, the method comprising:
providing an electronic circuit, the electronic circuit comprising:
a first mixer portion having a first stage and a second stage;
a second mixer portion having a first stage and a second stage;
a first electrical path coupled to the first mixer portion and the second mixer portion;
a second electrical path coupled to the first mixer portion and the second mixer portion;
a first input coupled to the first stage of the first mixer portion and the second stage of the second mixer portion; and
a second input coupled to the first stage of the second mixer portion and the second stage of the first mixer portion;
applying a first square wave to the first input; and
applying a second square wave to the second input, the first and second square waves having substantially the same frequency.

17. The method according to claim 16, further comprising filtering an output of the first and second mixer portions.

18. The method according to claim 16, further comprising determining a reactance based upon the first and second square waves.

19. An electronic circuit comprising:
a first resistor;
a second resistor;
a first current source;
a second current source;
a first transistor having a control terminal coupled to a first input node and a current path coupled between the first resistor and a first intermediate node;
a second transistor having a control terminal coupled to a second input node and a current path coupled between the second resistor and the first intermediate node;
a third transistor having a control terminal coupled to the second input node and a current path coupled between the first resistor and a second intermediate node;
a fourth transistor having a control terminal coupled to the first input node and a current path coupled between the second resistor and the second intermediate node;
a fifth transistor having a control terminal coupled to a third input node and a current path coupled between the first intermediate node and the first current source;
a sixth transistor having a control terminal coupled to a fourth input node and a current path coupled between the second intermediate node and the first current source;
a seventh transistor having a control terminal coupled to the third input node and a current path coupled between the second resistor and a third intermediate node;
an eighth transistor having a control terminal coupled to the fourth input node and a current path coupled between the first resistor and the third intermediate node;
a ninth transistor having a control terminal coupled to the fourth input node and a current path coupled between the second resistor and a fourth intermediate node;
a tenth transistor having a control terminal coupled to the third input node and a current path coupled between the first resistor and the fourth intermediate node;
an eleventh transistor having a control terminal coupled to the second input node and a current path coupled between the third intermediate node and the second current source; and
a twelfth transistor having a control terminal coupled to the first input node and a current path coupled between the fourth intermediate node and the second current source.

20. The electronic circuit of claim 19, wherein the first through twelfth transistors all comprise bipolar transistors.

21. The electronic circuit of claim 19, wherein the first resistor is coupled between a supply voltage line and the first, third, eighth and tenth transistors;
wherein the second resistor is coupled between the supply voltage line and the second, fourth, seventh and ninth transistors;
wherein the first current source is coupled between a ground voltage line and the fifth and sixth transistors; and
wherein the second current source is coupled between the ground voltage line and the eleventh and twelfth transistors.
